(19) United States
(12) Patent Application Publication
(10) Pub. No.: US 2014/0079961 A1
(43) Pub. Date: Mar. 20, 2014

(54) METHOD OF REPLENISHING LITHIUM FOR THE NEGATIVE PLATE OF A LI-ION BATTERY

(71) Applicants: NingDe Amperex Technology Limited, Ningde City (CN); Dongguan Amperex Technology Limited, Dongguan (CN)

(72) Inventors: Kaifu Zhong, Ningde City (CN); Zhen Chen, Ningde City (CN)

(21) Appl. No.: 13/906,862

(22) Filed: May 31, 2013

(30) Foreign Application Priority Data
Sep. 20, 2012 (CN) 201210351225.2

(51) Int. Cl. H01M 10/42

(52) U.S. Cl. CPC H01M 10/4242
USPC 429/49

(57) ABSTRACT

The invention pertains to the technical field of a Li-ion battery, in particular to a method of replenishing lithium for the negative plate of a Li-ion battery. Under inert atmosphere, organic lithium solution is sprayed or dripped on the negative plate surface so that lithium-ion in the organic lithium solution is reduced to lithium metal which is embedded in the negative plate, and then the negative plate is dried. Compared with the prior art, in the invention, the organic lithium solution is uniformly sprayed or dripped on the negative plate surface for realization of lithium replenishment by way of a wet process, thus effectively avoiding floating of lithium metal powder in the air during lithium replenishment by way of a dry process, which not only guarantees production safety, but also is characterized by simple process and lower cost.

### FIELD OF THE INVENTION

The invention pertains to the technical field of a Li-ion battery, in particular to a method of replenishing lithium for the negative plate of a Li-ion battery.

### BACKGROUND OF THE INVENTION

The Li-ion battery has an advantage of high voltage, high energy density and long cycle life, thus becoming one of secondary batteries with the widest application scope. With continuous development of microminiaturization and long stand-by time of portable electronics as well as use of high-power and high-energy equipment (for example, electric bicycles and electric automobiles etc), people are increasingly demanding for energy density of the Li-ion battery which serves as an energy-storage power supply.

As for the negative plate, in the initial charging process, a part of lithium is consumed due to formation of solid electrolyte membrane (an SEI membrane), thus causing loss of lithium (an anode material), reducing the battery capacity and initial coulombic efficiency. This is particularly obvious for a negative plate in which an alloy material (for example, silicon alloy and tin alloy etc) is used as the active material.

In order to decrease reduction of the battery capacity resulted from irreversible capacity in the initial charge-discharge process, a plurality of solutions are reported on patent literature. For example, in a Chinese patent application (Application No.: CN1290209C), lithium metal, negative electrode materials and non-aqueous liquid are blended to form a slurry, the slurry is coated on a current collector, then the slurry is dried and rolled, and then the electrolyte is poured into so that lithium powder is diffused into inside of the active material. This method can improve the initial coulombic efficiency. However, the whole operation needs to be carried out under an anhydrous dry environment due to higher reaction activity of the lithium metal, and the operation temperature needs to be controlled strictly, which results in a complex working procedure. Moreover, the non-aqueous liquid is incapable of reacting with the lithium metal in the mixing process and the non-aqueous liquid is mostly a flammable and explosive liquid, for example, tetrahydrofuran, methylbenzene and hydrocarbon solvents etc mentioned in the patent application. In addition, subsequent processes (for example, coating, cold pressing and winding) must be carried out under a dry environment, which leads to a higher cost for manufacturing the negative plate. Furthermore, the lithium powder is prone to floating upward because of its light weight, which causes difficulty in replenishing of lithium.

For example, a Japanese patent application (Application No.: JP1996027910), lithium tablets are covered on the negative plate, then wound into a battery, and then the Li-ion battery is made by pouring the electrolyte. This method can also play a role in replenishing lithium. However, the amount of lithium absorbed by the Li-ion battery is much less than that of lithium provided by the lithium tablets, which results in nonuniform lithium intercalation and deformation of the deformation; besides, the subsequent circulation is prone to precipitation of lithium.

In addition, in a Japanese patent application (Application No.: JP2005038720), a layer of lithium metal is deposited on the surface of the negative plate by means of vacuum evaporation. In the process, it is difficult to control thickness of the lithium metal layer although the lithium layer of evaporation is thinner than the lithium tablet. Besides, the whole process must be carried out under a vacuum environment, the evaporation efficiency is low, and it is relatively complex for transferring and handling of subsequent pole pieces with higher cost.

Moreover, a method of addition of dry powder can be used for replenishing lithium powder on the negative plate surface. However, the lithium powder is apt to floating in the air, which constitutes a major potential safety hazard for operating personnel.

On that account, it is indeed necessary to provide a method of replenishing lithium for the negative plate of a Li-ion battery. The method adopts “lithium replenishment by way of a wet process”, capable of effectively avoiding floating of lithium metal powder in the air during lithium replenishment by way of a dry process, thus guaranteeing production safety; also the method is characterized by simple process and lower cost. Replenishment amount of lithium can be accurately controlled by the amount of organic lithium solution sprayed or dripped or time of spraying or dripping the organic lithium solution, so as to achieve the aim of uniform replenishing of lithium.

### SUMMARY OF THE INVENTION

The aim of the invention is, in view of disadvantages of the prior art, to provide a method of replenishing lithium for the negative plate of a Li-ion battery. The method adopts “lithium replenishment by way of a wet process”, capable of effectively avoiding floating of lithium metal powder in the air during lithium replenishment by way of a dry process, thus guaranteeing production safety; also the method is characterized by simple process and lower cost. Replenishment amount of lithium can be accurately controlled by the amount of organic lithium solution sprayed or dripped or time of spraying or dripping the organic lithium solution, so as to achieve the aim of uniform replenishing of lithium, thus overcoming the disadvantages of the prior art which is characterized by nonuniform lithium intercalation, inaccurate lithium intercalation, demanding environmental requirements and high manufacturing cost.

In order to achieve the above-mentioned aim, the invention adopts such a technical scheme as below: a method of replenishing lithium for the negative plate of a Li-ion battery wherein under inert atmosphere, organic lithium solution is sprayed or dripped on the negative plate surface so that lithium-ion in the organic lithium solution is reduced to lithium metal which is embedded in the negative plate, and then the negative plate is dried.

As an improvement of the method of replenishing lithium for the negative plate of a Li-ion battery in the invention, the organic lithium solution is at least one of an n-hexane solution of n-butyllithium, an n-hexane solution of tert-butyllithium and an n-hexane solution of phenyl lithium. The n-butyllithium, tert-butyllithium and tert-butyllithium can be dissolved into n-hexane to form a uniform solution, thus being convenient for spraying or dripping the organic lithium solution on the negative plate surface.

As an improvement of the method of replenishing lithium for the negative plate of a Li-ion battery in the invention, the inert atmosphere is a nitrogen atmosphere or an argon atmosphere, the lithium metal, with higher reaction activity, is prone to accidents (for example, an explosion) in case of touching water vapor or carbon dioxide etc in the air. Consequently, the operation must be carried out under inert atmosphere so as to guarantee production safety.

As an improvement of the method of replenishing lithium for the negative plate of a Li-ion battery in the invention, preparation of the organic lithium solution is carried out under inert atmosphere by the specific operation as below: lithium powder is dissolved in an organic solvent; the organic solvent is at least one of biphenyl and dimethoxyethane; a chemical reaction takes place when lithium powder is dissolved in the organic solvent, during which, valence state of lithium is changed from 0 to +1 and a lithium compound is produced.

As an improvement of the method of replenishing lithium for the negative plate of a Li-ion battery in the invention, the organic lithium solution has a concentration of 0.1M-10M. The amount of organic lithium solution sprayed or dripped for replenishing lithium on the negative plate is too large if the concentration of the organic lithium solution is too low, thus resulting in a longer time for drying the negative plate in later period, affecting production efficiency and causing waste of the solvent; it is difficult to control replenishment amount of organic lithium solution when it is necessary to replenish lithium to the negative plate slightly if the concentration of the organic lithium solution is too high, which easily causes excessive replenishing of lithium and finally results in precipitation of lithium on the negative plate, thus triggering potential safety hazards.

Compared with the prior art, in the invention, organic lithium solution is uniformly sprayed or dripped on the negative plate surface for realization of lithium replenishment by way of a wet process, thus effectively avoiding floating of lithium metal powder in the air during lithium replenishment by way of a dry process, which not only guarantees production safety, but also is characterized by simple process and lower cost. Replenishment amount of lithium can be accurately controlled by the amount of organic lithium solution sprayed or dripped or time of spraying or dripping organic lithium solution, so as to achieve the aim of uniform replenishing of lithium, to prevent the negative plate from precipitation of lithium and deformation, to improve the initial coulombic efficiency of the battery, thus improving energy density and cycle performance of the battery. In addition, compared with a method of replenishing lithium by adding lithium metal into negative electrode slurry, the method does not have the problem of nonuniformity of the slurry or even maldistribution of lithium powder in the subsequent replenishing process resulted from floating upward of lighter lithium metal powder.

In addition, the invention also discloses another method of replenishing lithium for the negative plate of a Li-ion battery, under inert atmosphere the negative plate is immersed in the organic lithium solution so that lithium-ion in the organic lithium solution is reduced to lithium metal which is embedded in the negative plate, and then the negative plate is dried.

As an improvement of the method of replenishing lithium for the negative plate of a Li-ion battery in the invention, the organic lithium solution is at least one of an n-hexane solution of n-butyllithium, an n-hexane solution of tert-butyllithium and an n-hexane solution of phenyl lithium. The n-butyllithium, tert-butyllithium and tert-butyllithium can be dissolved into n-hexane to form a uniform solution, thus being convenient for uniform intercalation of lithium into the negative plate.

As an improvement of the method of replenishing lithium for the negative plate of a Li-ion battery in the invention, the inert atmosphere is a nitrogen atmosphere or an argon atmosphere, the lithium metal, with higher reaction activity, is prone to accidents (for example, an explosion) in case of touching water vapor or carbon dioxide etc in the air. Consequently, the operation must be carried out under inert atmosphere so as to guarantee production safety.

As an improvement of the method of replenishing lithium for the negative plate of a Li-ion battery in the invention, preparation of the organic lithium solution is carried out under inert atmosphere by the specific operation as below: lithium powder is dissolved in an organic solvent; the organic solvent is at least one of biphenyl and dimethoxyethane; a chemical reaction takes place when lithium powder is dissolved in the organic solvent, during which, valence state of lithium is changed from 0 to +1 and a lithium compound is produced.

As an improvement of the method of replenishing lithium for the negative plate of a Li-ion battery in the invention, the organic lithium solution has a concentration of 0.1M-10M. The amount of organic lithium solution sprayed or dripped for replenishing lithium on the negative plate is too large if the concentration of the organic lithium solution is too low, thus resulting in a longer time for drying the negative plate in later period, affecting production efficiency and causing waste of the solvent; it is difficult to control replenishment amount of organic lithium solution when it is necessary to replenish lithium to the negative plate if the concentration of the organic lithium solution is too high, which easily causes excessive replenishing of lithium and finally results in precipitation of lithium on the negative plate, thus triggering potential safety hazards.

Compared with the prior art, in the invention, organic lithium solution is uniformly sprayed or dripped on the negative plate surface for realization of lithium replenishment by way of a wet process, thus effectively avoiding floating of lithium metal powder in the air during lithium replenishment by way of a dry process, which not only guarantees production safety, but also is characterized by simple process and lower cost. Replenishment amount of lithium can be accurately controlled by the time of the negative plate immersing in the organic lithium solution, so as to achieve the aim of uniform replenishing of lithium, to prevent the negative plate from precipitation of lithium and deformation, to improve the initial coulombic efficiency of the battery, thus improving energy density and cycle performance of the battery. In addition, compared with a method of replenishing lithium by adding lithium metal into negative electrode slurry, the method does not have the problem of nonuniformity of the slurry or even maldistribution of lithium powder in the subsequent replenishing process resulted from floating upward of lighter lithium metal powder.

### DETAILED DESCRIPTION OF THE EMBODIMENTS

The invention provides a method of replenishing lithium for the negative plate of a Li-ion battery.

### Embodiment 1

The embodiment provides a method of replenishing lithium for the negative plate of a Li-ion battery. In nitrogen atmosphere, an n-hexane solution of n-butyllithium with a concentration of 1M is sprayed on the negative plate surface (the active material in the negative plate is graphite) so that lithium-ion in n-butyllithium is reduced to lithium metal which is embedded in the negative plate and amount of lithium embedded in graphite accounts for 5% of the total capacity of graphite, and then the negative plate is dried, operation of lithium replenishing being completed.

### Embodiment 2

The embodiment provides a method of replenishing lithium for the negative plate of a Li-ion battery. In argon atmosphere, an n-hexane solution of tert-butyllithium with a concentration of 3M is dripped on the negative plate surface (the active material in the negative plate is graphite) so that lithium-ion in the organic lithium solution is reduced to lithium metal which is embedded in the negative plate and amount of lithium embedded in graphite accounts for 15% of the total capacity of graphite, and then the negative plate is dried, operation of lithium replenishing being completed.

### Embodiment 3

The embodiment provides a method of replenishing lithium for the negative plate of a Li-ion battery. In nitrogen atmosphere, an n-hexane solution of phenyl lithium with a concentration of 5M is dripped on the negative plate surface (the active material in the negative plate is silicon) so that lithium-ion in phenyl lithium is reduced to lithium metal which is embedded in the negative plate and amount of lithium embedded in silicon accounts for 0.01% of the total capacity of silicon, and then the negative plate is dried, operation of lithium replenishing being completed.

### Embodiment 4

The embodiment provides a method of replenishing lithium for the negative plate of a Li-ion battery. In argon atmosphere, a mixed solution made up of n-hexane solution of n-butyllithium and n-hexane solution of tert-butyllithium with a concentration of 0.5M respectively is dripped on the negative plate surface (the active material in the negative plate is silicon) so that lithium-ion in n-butyllithium is reduced to lithium metal which is embedded in the negative plate and amount of lithium embedded in silicon accounts for 20% of the total capacity of silicon, and then the negative plate is dried, operation of lithium replenishing being completed.

### Embodiment 5

The embodiment provides a method of replenishing lithium for the negative plate of a Li-ion battery. In argon atmosphere, lithium powder is dissolved in biphenyl, an organic lithium solution with a concentration of 0.1M is obtained; the organic lithium solution is sprayed on the negative plate surface (the active material in the negative plate is graphite) so that lithium-ion in the organic lithium solution is reduced to lithium metal which is embedded in the negative plate and amount of lithium embedded in graphite accounts for 2% of the total capacity of graphite, and then the negative plate is dried, operation of lithium replenishing being completed.

### Embodiment 6

The embodiment provides a method of replenishing lithium for the negative plate of a Li-ion battery. In nitrogen atmosphere, lithium powder is dissolved in dimethoxyethane, an organic lithium solution with a concentration of 10M is obtained; the organic lithium solution is sprayed on the negative plate surface (the active material in the negative plate is graphite) so that lithium-ion in the organic lithium solution is reduced to lithium metal which is embedded in the negative plate and amount of lithium embedded in graphite accounts for 5% of the total capacity of graphite, and then the negative plate is dried, operation of lithium replenishing being completed.

### Embodiment 7

The embodiment provides a method of replenishing lithium for the negative plate of a Li-ion battery. In nitrogen atmosphere, lithium powder is dissolved in a mixed solvent made up of dimethoxyethane and biphenyl by a volume ratio of 4:1, an organic lithium solution with a concentration of 10M is obtained; the organic lithium solution is sprayed on the negative plate surface (the active material in the negative plate is a mixture made up of graphite and silicon by a mass ratio of 4:1) so that lithium-ion in the organic lithium solution is reduced to lithium metal which is embedded in the negative plate and amount of lithium embedded in the active material accounts for 12% of the total capacity of the active material, and then the negative plate is dried, operation of lithium replenishing being completed.

The negative plates (subject to lithium replenishing) in Embodiments 1-7, positive plates and diaphragms are respectively wound into a battery cell, which is then subject to processing such as tip-sealing, liquid charging (thickness of lithium salt being 1 mol/L), standing, forming (formation capacity being ICC0), reshaping and degassing etc., in this way, a Li-ion battery is made. The Li-ion battery made respectively by using the negative plates in Embodiments 1-7 are consecutively numbered as S1-S7.

The negative plates (prior to lithium replenishing) in Embodiments 1 and 7, positive plates and diaphragms are respectively wound into a battery cell, which is then subject to processing such as tip-sealing, liquid charging (thickness of lithium salt being 1 mol/L), standing, forming (formation capacity being ICC0), reshaping and degassing etc., in this way, a Li-ion battery is made. The Li-ion battery made respectively by using the negative plates in Embodiments 1 and 7 are consecutively numbered as D1-D2.

The invention also discloses another method of replenishing lithium for the negative plate of a Li-ion battery.

### Embodiment 1

The embodiment provides a method of replenishing lithium for the negative plate of a Li-ion battery. In argon atmosphere, lithium powder is dissolved in dimethoxyethane, an organic lithium solution with a concentration of 6M is obtained; the negative plate (the active material in the negative plate is graphite) is immersed in the organic lithium solution so that lithium-ion in the organic lithium solution is reduced to lithium metal which is embedded in the negative plate and amount of lithium embedded in graphite accounts for 8% of the total capacity of graphite, and then the negative plate is dried, operation of lithium replenishing being completed.

### Embodiment 2

The embodiment provides a method of replenishing lithium for the negative plate of a Li-ion battery. In argon atmosphere, lithium powder is dissolved in biphenyl, an organic lithium solution with a concentration of 4M is obtained; the negative plate (the active material in the negative plate is graphite) is immersed in the organic lithium solution so that lithium-ion in the organic lithium solution is reduced to lithium metal which is embedded in the negative plate and amount of lithium embedded in graphite accounts for 10% of the total capacity of graphite, and then the negative plate is dried, operation of lithium replenishing being completed.

### Embodiment 3

The embodiment provides a method of replenishing lithium for the negative plate of a Li-ion battery. In argon atmosphere, the negative plate (the active material in the negative plate is silicon) is immersed in n-hexane solution of n-butyllithium with a concentrate of 3.5M so that lithium-ion in n-butyllithium is reduced to lithium metal which is embedded in the negative plate and amount of lithium embedded in silicon accounts for 10% of the total capacity of silicon, and then the negative plate is dried, operation of lithium replenishing being completed.

### Embodiment 4

The embodiment provides a method of replenishing lithium for the negative plate of a Li-ion battery. In nitrogen atmosphere, the negative plate (the active material in the negative plate is graphite) is immersed in n-hexane solution of tert-butyllithium with a concentrate of 7.5M so that lithium-ion in tert-butyllithium is reduced to lithium metal which is embedded in the negative plate and amount of lithium embedded in graphite accounts for 15% of the total capacity of graphite, and then the negative plate is dried, operation of lithium replenishing being completed.

### Embodiment 5

The embodiment provides a method of replenishing lithium for the negative plate of a Li-ion battery. In nitrogen atmosphere, the negative plate (the active material in the negative plate is graphite) is immersed in n-hexane solution of phenyl lithium with a concentrate of 9M so that lithium-ion in phenyl lithium is reduced to lithium metal which is embedded in the negative plate and amount of lithium embedded in graphite accounts for 15% of the total capacity of graphite, and then the negative plate is dried, operation of lithium replenishing being completed.

The negative plates (subject to lithium replenishing) in Embodiments 1-5, positive plates and diaphragms are respectively wound into a battery cell, which is then subject to processing such as tip-sealing, liquid charging (thickness of lithium salt being 1 mol/L), standing, forming (formation capacity being ICC0), reshaping and degassing etc., in this way, a Li-ion battery is made. The Li-ion battery made respectively by using the negative plates in Embodiments 1-5 are consecutively numbered as S8-S12.

The negative plate (prior to lithium replenishing) in Embodiment 3, the positive plate and the diaphragm are respectively wound into a battery cell, which is then subject to processing such as tip-sealing, liquid charging (thickness of lithium salt being 1 mol/L), standing, forming (formation capacity being ICC0), reshaping and degassing etc., in this way, a Li-ion battery is made and numbered as D3.

Under a temperature of 35° C., a capacity test is respectively made for batteries numbered as S1-S12 and D1-D3 by such a technological process as below: first, the batteries are subject to standing for 3min, then charged to 4.2V at a constant charging current of 0.5C, and then recharged to 0.05C at a constant voltage, with a charging capacity of AGC0 obtained; again the batteries are subject to standing for 3min, then discharged to 3.0V at a constant discharging current of 0.5C, with an initial discharge capacity of D0 obtained; then the batteries are subject to standing for 3 min once more and a capacity test is finished; finally the initial coulombic efficiency of the battery cell is calculated by the following formula: D0/(ICC0+AGC0), with the results shown in Table 1.

Under a temperature of 25° C., a cycle performance test is respectively made for batteries numbered as S1-S12 and D1-D3 at a charge/discharge rate of 0.5C/0.5C, the battery capacity after the initial charge is recorded as C0, and the battery capacity after 500 cycles is recorded as C500; finally the battery capacity retention rate after 500 cycles is calculated by the following formula: C500/C0, with the results shown in Table 1.

TABLE 1
Capacity test results and initial coulombic efficiency
of batteries numbered as S1-S12

| | | | | Battery |
|---|---|---|---|---|
| | | | Initial | capacity |
| | ICC0 + AGC0 | D0 | coulombic | retention rate |
| No. | (mAh) | (mAh) | efficiency | after 500 cycles |
| S1 | 1578 | 1499 | 95% | 92% |
| S2 | 1578 | 1578 | 100% | 90% |
| S3 | 2308 | 1500.2 | 65.01% | 88% |
| S4 | 2308 | 2123 | 92% | 89% |
| S5 | 1578 | 1562 | 99% | 90% |
| S6 | 1578 | 1568 | 99% | 91% |
| S7 | 1718 | 1598 | 93% | 89% |
| S8 | 1578 | 1568 | 99% | 92% |
| S9 | 1578 | 1546 | 98% | 92% |
| S10 | 2308 | 2077 | 90% | 91% |
| S11 | 1578 | 1499 | 95% | 92% |
| S12 | 1578 | 1515 | 96% | 92% |
| D1 | 1578 | 1420 | 90% | 85% |
| D2 | 1718 | 1460 | 85% | 84% |
| D3 | 2308 | 1500 | 65% | 82% |

From Table 1 we can see that, active materials of anodes of batteries numbered as S1, S2, S5, S6, S8, S9, S11, S12 and D1 are graphite, by comparing initial coulombic efficiency of the batteries we can find that: initial coulombic efficiency of batteries using lithium-rich negative plates made by adopting the method of the invention is obviously improved, and battery capacity retention rate after 500 cycles is also greatly increased; active materials of anodes of batteries numbered as S3, S4, S10 and D3 are silicon, from the test results of the battery numbered as D3 we can see that, initial coulombic efficiency of batteries using silicon as their anode active materials is lower (65%); however, the initial coulombic efficiency of these batteries is improved (see test results of the battery numbered as S3) even though they are subject to slight lithium replenishing by adopting the method of the invention, both the initial coulombic efficiency and cycle performance (battery capacity retention rate after 500 cycles) of these batteries are significantly improved by adequate lithium replenishing (see test results of the batteries numbered as S4 and S10); the batteries numbered as S7 and D2 use a mixture of silicon and graphite by a mass ratio of 1:4 as the anode active materials, by comparing initial coulombic efficiency of the batteries numbered as S7 and D2 we can obviously see that: the negative plates made by adopting the method of the invention can significantly improve initial coulombic efficiency and cycle performance of batteries.

It is necessary to state that, those skilled in the art can use other frequently-used anode materials (for example, silicon-carbon alloy and tin alloy etc) although in the invention only graphite and silicon are taken an example as the anode active materials.

In conclusion, in the invention, the organic lithium solution is uniformly sprayed or dripped on the negative plate surface for realization of lithium replenishment by way of a wet process, thus effectively avoiding floating of lithium metal powder in the air during lithium replenishment by way of a dry process, which not only guarantees production safety, but also is characterized by simple process and lower cost. Replenishment amount of lithium can be accurately controlled by the amount of organic lithium solution sprayed or dripped or time of spraying or dripping the organic lithium solution, so as to achieve the aim of uniform replenishing of lithium, to prevent the negative plate from precipitation of lithium and deformation, to improve the initial coulombic efficiency of the battery, thus improving energy density of the battery and significantly improving cycle performance of the battery. In addition, compared with a method of replenishing lithium by adding lithium metal into negative electrode slurry, the method of the invention does not have the problem of nonuniformity of the slurry or even maldistribution of lithium powder in the subsequent replenishing process resulted from floating upward of lighter lithium metal powder.

The method of replenishing lithium for the negative plate of a Li-ion battery mentioned in the invention is subject to detailed description by the embodiments mentioned-above. Those skilled in the art can, on the basis of violating content, spirit and scope of the invention, make a modification or appropriate change or combination of the method of the invention so as to realize the technology of the invention. It is necessary to be point out particularly, all similar substitution or modification of the method, which is obvious to those skilled in the art, shall be regarded as within the content, spirit and scope of the invention.

What is claimed is:

1. A method of replenishing lithium for the negative plate of a Li-ion battery wherein under inert atmosphere, organic lithium solution is sprayed or dripped on the negative plate surface so that lithium-ion in the organic lithium solution is reduced to lithium metal which is embedded in the negative plate, and then the negative plate is dried.

2. The method of replenishing lithium for the negative plate of a Li-ion battery according to claim 1, wherein the organic lithium solution is at least one of an n-hexane solution of n-butyllithium, an n-hexane solution of tert-butyllithium and an n-hexane solution of phenyl lithium.

3. The method of replenishing lithium for the negative plate of a Li-ion battery according to claim 1, wherein the inert atmosphere is a nitrogen atmosphere or an argon atmosphere.

4. The method of replenishing lithium for the negative plate of a Li-ion battery according to claim 1, wherein preparation of the organic lithium solution is carried out under inert atmosphere by the specific operation as below: lithium metal powder is dissolved in an organic solvent; the organic solvent is at least one of biphenyl and dimethoxyethane.

5. The method of replenishing lithium for the negative plate of a Li-ion battery according to claim 1, wherein the organic lithium solution has a concentration of 0.1M-10M.

6. A method of replenishing lithium for the negative plate of a Li-ion battery wherein under inert atmosphere the negative plate is immersed in the organic lithium solution so that lithium-ion in the organic lithium solution is reduced to lithium metal which is embedded in the negative plate, and then the negative plate is dried.

7. The method of replenishing lithium for the negative plate of a Li-ion battery according to claim 6, wherein the organic lithium solution is at least one of an n-hexane solution of n-butyllithium, an n-hexane solution of tert-butyllithium and an n-hexane solution of phenyl lithium.

8. The method of replenishing lithium for the negative plate of a Li-ion battery according to claim 6, wherein the inert atmosphere is a nitrogen atmosphere or an argon atmosphere.

9. The method of replenishing lithium for the negative plate of a Li-ion battery according to claim 6, wherein preparation of the organic lithium solution is carried out under inert atmosphere by the specific operation as below: lithium metal powder is dissolved in an organic solvent; the organic solvent is at least one of biphenyl and dimethoxyethane.

10. The method of replenishing lithium for the negative plate of a Li-ion battery according to claim 6, wherein the organic lithium solution has a concentration of 0.1M-10M.
